(19) United States
(12) Patent Application Publication
(10) Pub. No.: US 2017/0240081 A1
(43) Pub. Date: Aug. 24, 2017

(54) FASTENING STRIP FOR FIXING A SEAT COVERING TO A SEAT CUSHION OF A CAR

(71) Applicant: Taiwan Paiho Limited, Chang Hwa Hsien (TW)

(72) Inventor: Allen CHENG, Chang Hwa Hsien (TW)

(21) Appl. No.: 15/154,269

(22) Filed: May 13, 2016

(30) Foreign Application Priority Data
Feb. 23, 2016 (TW) 105202486

(51) Int. Cl. B60N 2/58; A44B 18/00

(52) U.S. Cl. CPC B60N 2/5825; A44B 18/008; A44B 18/0061

(57) ABSTRACT

One aspect of the present invention provides a fastening strap for fixing a seat covering to a seat cushion of a car. The fastening strap includes a plurality of fastening sections connected in series and each of the fastening section comprises: a substrate having a plurality of hooks formed on a surface thereof; at least one magnetic member disposed on the surface of the substrate; a protective member disposed along a periphery of the substrate to encircle the plurality of hooks; and a flexible connecting portion integrally extending from one end of the substrate in a longitudinal direction of the fastening section to connect to an adjacent fastening section in a spaced apart manner.

### FIELD OF THE INVENTION

The present invention relates generally to a sideway-bendable fastening strip for fixing a seat covering to a seat cushion of a car.

### BACKGROUND OF THE INVENTION

Traditionally, a manufacture of a seat cushion of a car involves injecting a foam material into a pre-designed mold to form a seat cushion with a desired shape. Additionally, after a seat cushion is formed, a seat covering needs to be fit to the seat cushion to cover it and to give it an aesthetics appearance. In the past, fixing a seat covering to a seat cushion of a car mainly uses steel wires as fixing means and it is a tedious and heavy machinery process which could easily causes permanent damage to the seat cushion.

In order to improve the above-mentioned drawbacks of the traditional procedure, recent approaches dispose hook straps in the seat cushion to engage with the loop members provided on the seat covering so as to fix the seat covering to the seat cushion. Specifically, during the forming of the seat cushion, fastening straps are placed at predetermined locations in the pre-designed mold and then the foam material is injected into the mold, thereby the fastening straps will be integrated in the seat cushion at desired locations.

FIG. 1 illustrates one example of this fastening strap used in a seat cushion of a car. As shown in FIG. 1, the fastening strap 30 includes a substrate 31 made of a material that allows foam material to penetrate into the voids of the material, such as non-woven fabric or fibrous fabric. This hook strap 30 further includes a magnetic material layer 32 coated on the substrate 31 and an engaging member 40 bonded to the magnetic material layer 32. The engaging member 40 has a plurality of hooks 43 formed thereon to form an engaging face. Additionally, the substrate 31 has two longitudinal sidewalls 33 each formed along the sides of the engaging member 40 and having a height greater than a height of the hooks 43, so as to prevent the foam material from entering the spaces between the hooks 43 during a foaming process of a seat cushion manufacturing.

Another example of this fastening strap used in a seat cushion of a car is shown in FIG. 2. As illustrated in FIG. 2, the fastening strap 50 includes a substrate 51 and a fastening member 60 having hooks 63 formed thereon. Instead of having two protective sidewalls, this fastening strap 50 includes a protective layer 70 that is directly and detachably attached to the fastening member 60 and cover the hooks 63 so as to provide a protective function to prevent the foam material from entering the spaces between the hooks 63 during the foaming process of a seat cushion manufacturing.

Although the above-mentioned hook straps used in a seat cushion of a car may provide a function of fixing the seat coverings onto a seat cushion, they have drawbacks and application limitations.

For instance, in addition to provide a comfortable seat for a passenger to sit in, it is more emphasized on the appearance of the seats of a car nowadays to match with the interior design of a car so as to manifest the characteristics of a specific brand of a car and/or a specific model of a car. Thus, it is more often then ever that the design of a seat for a modern car consists of shapes having many different curvatures. However, the above-mentioned prior art fastening straps are unable to bend or curve sideway, they can only be used in seat cushions that have substantially straight fixing grooves. For seat cushions having curved fixing grooves, extra processes need to be taken to allow the above-mentioned prior art fastening straps to be applied. For instance, additional cutting molds having specific curvatures that match with the curvatures of the curved fixing grooves of a specific seat cushion to which the fastening straps are to be applied need to be developed to cut the fastening straps into shapes having desired curvatures. However, this is not cost effective because a specific cutting mold needs to be developed for a curved fixing groove of a seat cushion, and if there are a number of curved fixing grooves of different curvatures in one seat cushion then a number of different cutting molds are needed to cut the fastening straps into desired shapes. Thus, the applicability of the prior art fastening straps is limited.

Therefore, there exists a need in seat cushion of a car for a fastening strap that is able to provide a strong bonding between the fastening strap and the seat cushion, and is capable of bending or curving sideway so as to be applicable to seat cushions having straight and curved fixing grooves without any extra processes.

### SUMMARY OF THE INVENTION

In view of the above-mentioned disadvantages/problems associated with the existing fastening straps used in a seat cushion of a car, one object of the present invention is to provide a fastening strap used in a seat cushion of a car to allow the design of a seat of a car has limitations on it contour much less than before and is much easier to utilize and more cost efficient.

According to one embodiment of the present invention, a fastening strap is provided, which includes a plurality of fastening sections connected in series, each of the fastening section comprising:

a substrate having a plurality of hooks formed on a surface thereof;

at least one magnetic member disposed on the surface of the substrate;

a protective member disposed along a periphery of the substrate to encircle the plurality of hooks; and

a flexible connecting portion integrally extending from one end of the substrate in a longitudinal direction of the fastening section to connect to an adjacent fastening section in a spaced apart manner.

The connection portion has a height t and a width w and the height is greater than the width, i.e., t w. Additionally, the protecting member has a height measured from the surface of the substrate which is greater than a height of the hook that is measured from the surface of the substrate. The fastening section further comprises wing portions that extend outwardly from lateral sides of the substrate respectively.

Other features and advantages of the present invention will become clear from reading the description of the present specification with reference to the accompanying drawings.

### BRIEF DESCRIPTION OF THE DRAWINGS

For a more complete understanding of the present invention and the advantages thereof, reference is now made to the following description taken in conjunction with the accompanying drawings, wherein:

FIG. 1 is a schematic cross-sectional view illustrating a prior art fastening strap structure used in a seat cushion of a car;

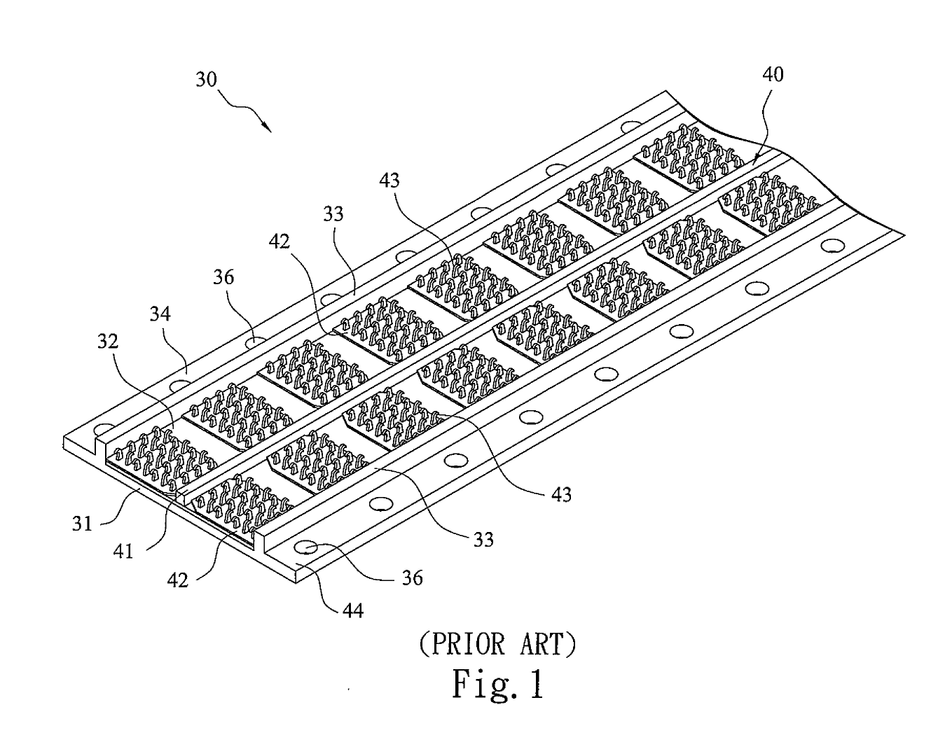

FIG. 2 is a schematic cross-sectional view illustrating another prior art fastening strap structure used in a seat cushion of a car;

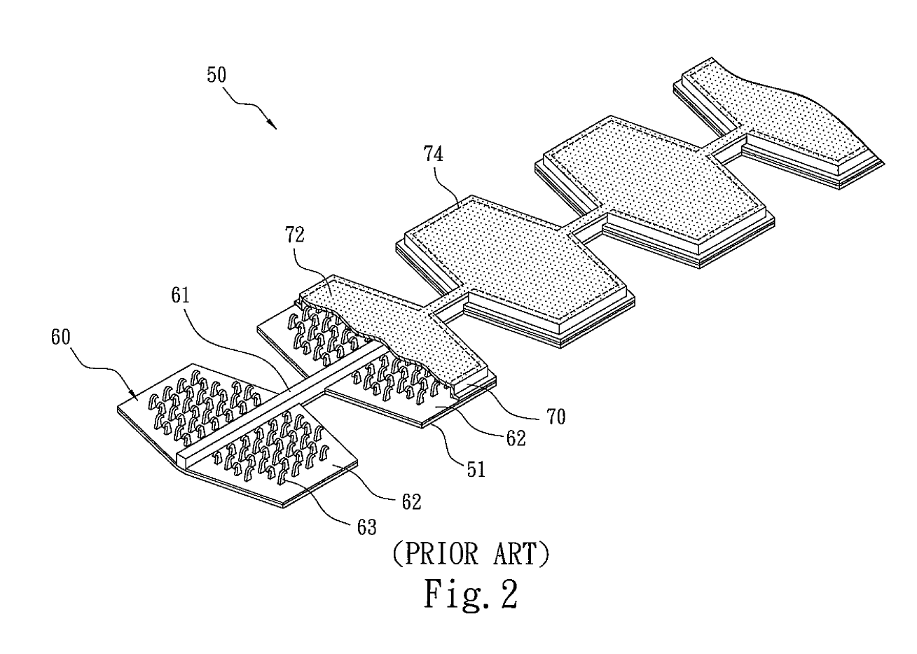

FIG. 3 is a schematic perspective view showing a fastening strap for fixing a seat covering to a seat cushion of a car according to an embodiment of the present invention;

FIG. 4 is a top plane view of the fastening strap shown in FIG. 3;

FIG. 5 is a schematic cross-sectional view taking along line A-A of FIG. 4; and

FIG. 6 is a schematic perspective view showing a fastening strap according to another embodiment of the present invention.

### DETAILED DESCRIPTION OF THE INVENTION

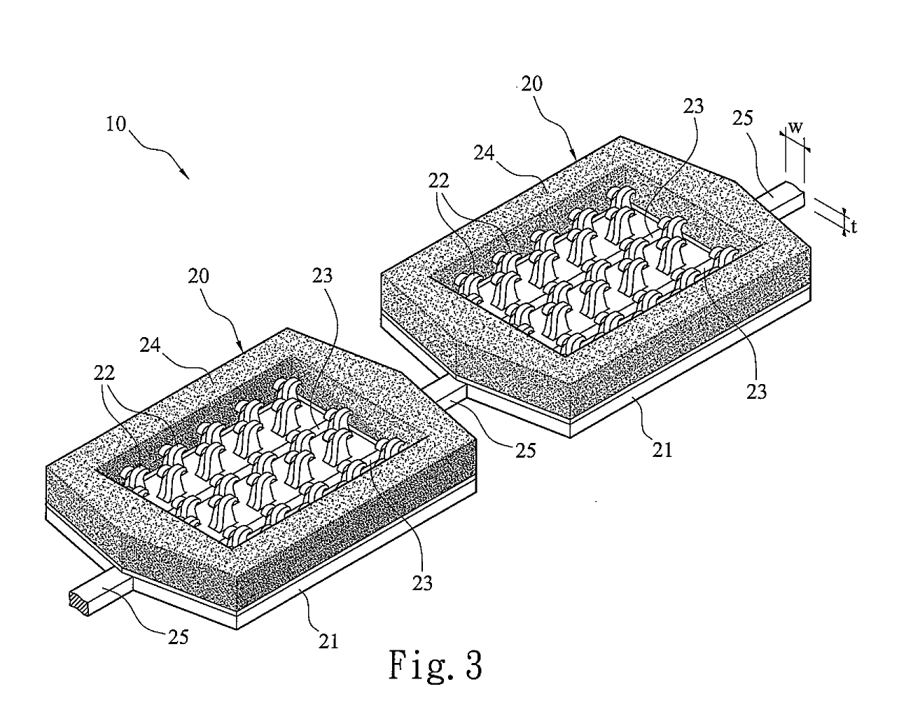

Referring now to FIGS. 3-6 in which preferred embodiments of the fastening strap of the present invention are illustrated to describe the present invention.

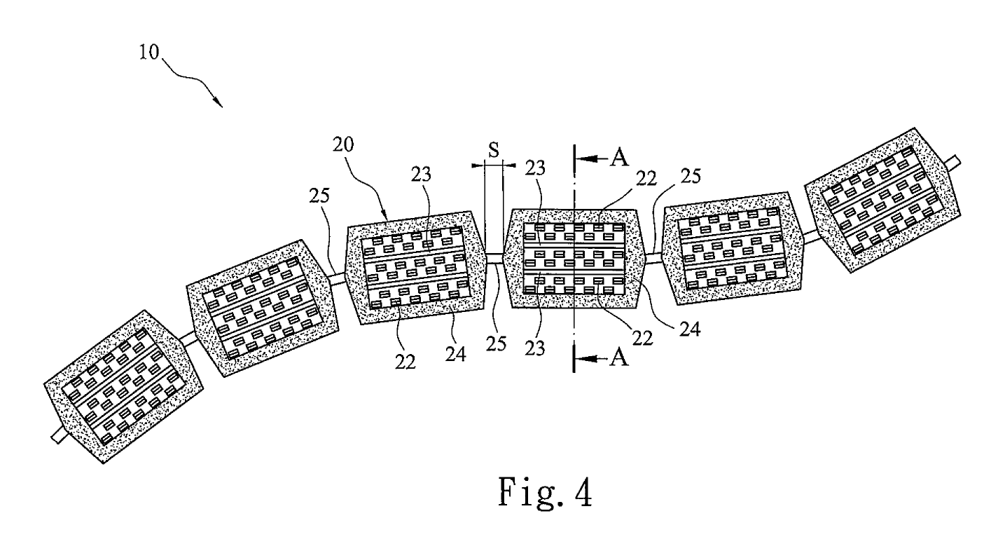

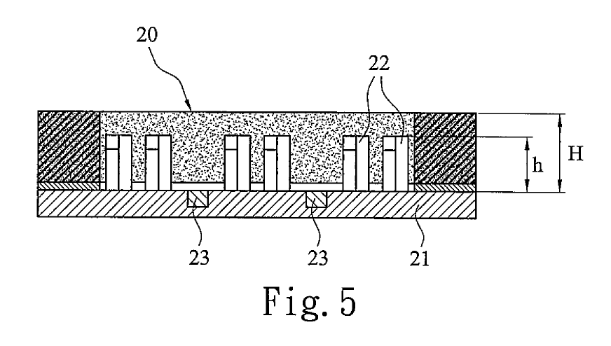

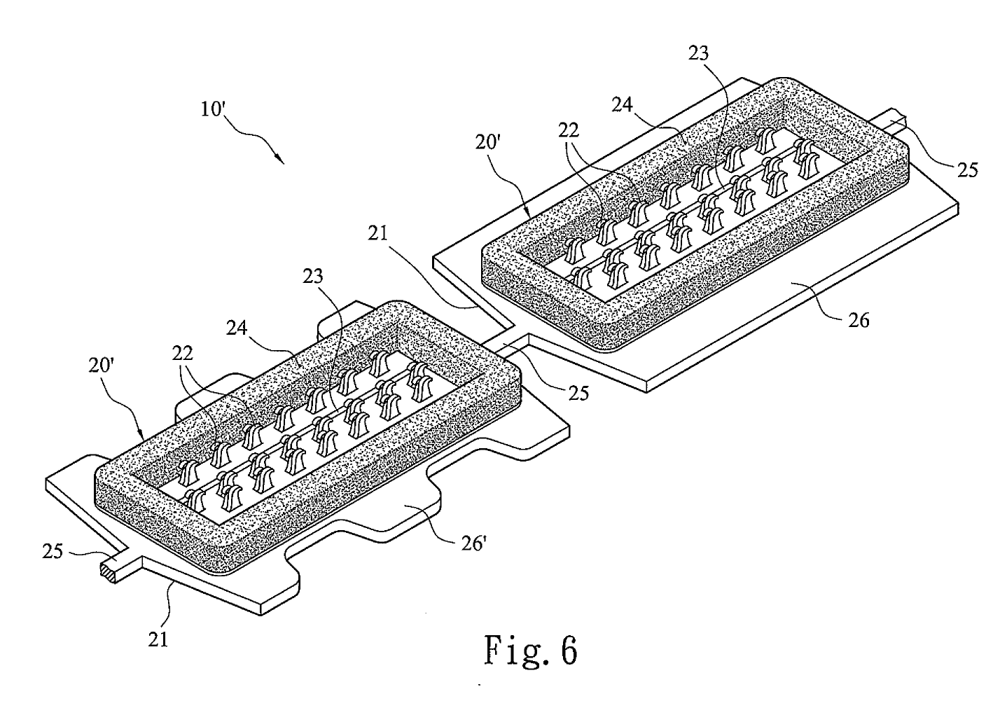

FIG. 3 is a schematic perspective view illustrating a fastening strap 10 for fixing a seat covering to a seat cushion of a car according to a preferred embodiment of the present invention. FIG. 4 is a top plane view of the fastening strap 10 shown in FIG. 3. FIG. 5 is a schematic cross-sectional view taking along line A-A of FIG. 4. FIG. 6 is a schematic perspective view showing a fastening strap 10′ according to another embodiment of the present invention.

As shown in FIGS. 3 and 4, the fastening strap 10 of the present invention includes a plurality of fastening sections 20 connected in series. Each of the fastening section 20 comprises a substrate 21 having a plurality of hooks 22 formed on a surface thereof; at least one magnetic member 23 disposed on the surface of the substrate 21; a protective member 24 disposed along a periphery of the substrate 21 to encircle the plurality of hooks 22; and a flexible connecting portion 25 integrally extending from one end of the substrate 21 in a longitudinal direction of the fastening section 20 to connect to an adjacent fastening section 20 in series so that adjacent fastening sections 20 are spaced apart at a distance S.

In the embodiment illustrated in FIGS. 3-5, the at least one magnetic member 23 comprise two steel wires. However, it should be understood that the magnetic member 23 is not limited to this. For instance, the magnetic member 23 may comprises a magnetic coating or other magnetic element that is applied to the substrate 21.

Additionally, in the embodiment illustrated in FIGS. 3-5, the protective member 24 is made of a foam material and is adhered to the substrate 21 along a periphery thereof. However, it should be understood that the protective member 24 is not limited to this. For instance, the protective member 24 may comprises a wall (not illustrated) that extends upwardly from the surface of the substrate 21 along the periphery thereof to encircle the hooks 22. Additionally, the protective member 24 has a height H which is greater than a height h of the hooks 22 in order to prevent the foam material from entering the space among the hooks 22. Moreover, as seen from the drawings, the connecting portion 25 has height t and a width w and the height is greater than the width, i.e., t≧w, to ensure both the robustness and the flexibility of the connecting portion 25.

Next, reference is made to FIG. 6, in which a fastening strap 10′ for fixing a seat covering to a seat cushion of a car according to another embodiment of the present invention is illustrated. The fastening strap 10′, similar to the fastening strap 10 of FIGS. 3-5, includes a plurality of fastening sections 20′ connected in series, wherein each of the fastening section 20′ comprises a substrate 21, a plurality of hooks 22 formed on the substrate 21, at least one magnetic member 23, a protective member 24 and a connecting portion 25. The fastening strap 10′ further comprises side wings 26 extending outwardly from lateral sides of the substrate 21 which allow the foam material to cover these side wings 26 during the foaming process of the seat cushion so as to provide additional mechanical bonding force between the fastening strap 10′ and the seat cushion and to enhance the bonding between the fastening strap 10′ and the seat cushion. Additionally, as illustrated in FIG. 6, in addition to a continuous configuration (e.g., side wings 26), the side wings may has a discontinuous protrusion configuration (e.g., side wings 26′).

Because the fastening strap of the present invention comprises the unique structural features described above, the fastening strap of the present invention possesses a function/advantage that existing prior art fastening straps do not have (that is, the fastening strap of the present invention can be arbitrarily bent/curved sideway). Therefore, the fastening strap of the present invention is not only applicable to seat cushions having straight bonding grooves, but also applicable to seat cushions having curved bonding grooves with different curvatures and different curving orientations directly and without any additional processing. Therefore, the fastening strap of the present invention is a creation that has a great industrial applicability.

Although the present invention has been described above according to the preferred embodiments thereof, it does not intend to limit the scope of the present invention to specific structural features described above. In fact, there exist various modifications and variations under the principle and spirit disclosed above. For instance, in the above described embodiments, the fastening sections are illustrated in a form with a rectangular shape, however, the fastening sections may have other shapes, for example, the fastening sections may have a semi-circular shape.

It will be apparent to people skilled in this art that many modifications can be made to the disclosed structures without departing from the scope of the invention. Therefore, it is the intent of the appended claims to cover all such variations and modifications as come within the sprit and scope of this invention.

What is claimed is:

1. A fastening strap for fixing a seat covering to a seat cushion of a car, comprising:
a plurality of fastening sections connected in series, each of the fastening section comprising:
a substrate having a plurality of hooks formed on a surface thereof;
at least one magnetic member disposed on the surface of the substrate;
a protective member disposed along a periphery of the substrate to encircle the plurality of hooks; and
a flexible connecting portion integrally extending from one end of the substrate in a longitudinal direction of the fastening section to connect to an adjacent fastening section in a spaced apart manner.

2. A fastening strap according to claim 1, wherein the connection portion has a height t and a width w and the height is greater than the width, i.e., t≧w.

3. A fastening strap according to claim 1, wherein the protecting member has a height measured from the surface of the substrate which is greater than a height of the hook that is measured from the surface of the substrate.

4. A fastening strap according to claim 1, wherein the fastening section further comprises wing portions that extend outwardly from lateral sides of the substrate.
